(19) United States
(12) Patent Application Publication
(10) Pub. No.: US 2022/0157218 A1
(43) Pub. Date: May 19, 2022

(54) DISPLAY SCREEN AND PROCESSING APPARATUS FOR DRIVING A DISPLAY SCREEN AND METHODS OF OPERATION

(71) Applicant: Vestel Elektronik Sanayi ve Ticaret A.S., Manisa (TR)

(72) Inventor: Ísmail YILMAZLAR, Manisa (TR)

(21) Appl. No.: 17/599,982

(22) PCT Filed: Mar. 29, 2019
(86) PCT No.: PCT/EP2019/058078

§ 371 Date: Sep. 29, 2021

(51) Int. Cl. G09G 3/20

(52) U.S. Cl. CPC G09G 3/20; G09G 2360/10; G09G 2300/0452

(57) ABSTRACT

Processing apparatus for driving a display screen having one or more visible light pixels for outputting visible light and one or more invisible light pixels for outputting invisible light. The processing apparatus has an input for receiving video image and audio signals. A video processor processes input video image signals received at the input and provides corresponding drive signals for driving the one or more visible light pixels of the display screen to output visible light so as to display the video image. An audio processor processes input audio signals received at the input and provides corresponding drive signals for driving the one or more invisible light pixels of the display screen to output invisible light which encodes the audio.

### TECHNICAL FIELD

The present disclosure relates to a processing apparatus for driving a display screen, a display screen, and related methods.

### BACKGROUND

People often use wireless headphones to listen to audio when watching an associated video on some device. This may be so that the user can listen to the audio without disturbing others or to block out noise in the environment. In other situations, audio may be transmitted wirelessly to some other audio playback device, such as wireless loudspeakers. In either case, the audio is typically transmitted to the audio playback device using Bluetooth or WiFi. This however can cause interference to other Bluetooth or WiFi signals in the environment, and other Bluetooth or WiFi signals in the environment can cause interference to the wireless audio signals that are being transmitted. Moreover, it also requires a separate Bluetooth or WiFi transmitter to be provided. Also, in some cases, the video and audio may not be synchronised during play back.

### SUMMARY

According to a first aspect disclosed herein, there is provided processing apparatus for driving a display screen having one or more visible light pixels for outputting visible light and one or more invisible light pixels for outputting invisible light, the apparatus comprising:

an input for receiving video image and audio signals;

a video processor constructed and arranged to process input video image signals received at the input and to provide corresponding drive signals for driving the one or more visible light pixels of a said display screen to output visible light so as to display the video image; and

an audio processor constructed and arranged to process input audio signals received at the input and to provide corresponding drive signals for driving the one or more invisible light pixels of a said display screen to output invisible light which encodes the audio.

The invisible light which encodes the audio can be received by a corresponding receiver of an audio playback device, such as for example headphones or loudspeakers. The use of invisible light pixels in the display screen to output invisible light which encodes the audio has a number of advantages. For example, a separate transmitter arrangement for wirelessly transmitting encoded audio to the audio playback device is not required. Also, the invisible light may have a frequency that does not cause interference with other wireless signals that may be present in the environment, such as Bluetooth or WiFi wireless signals. The invisible light for the audio does not interfere with the user being able to view the image that is being displayed in use by the display screen.

The “pixels” of the display screen may be so-called sub-pixels. The display screen may in general use any suitable display technology to display images and to output the invisible light encoded with audio, including for example LCD (liquid crystal display) with an LED (light emitting diode) or other backlight; emissive elements such as LEDs, OLEDs (organic LEDs), plasma; etc.

In an example, the processing apparatus is arranged such that the processing of the input video image signals and the processing of the input audio signals takes substantially the same amount of time such that the corresponding drive signals for driving the one or more visible light pixels of a said display screen and the drive signals for driving the one or more invisible light pixels of a said display screen are substantially synchronised with each other.

In an example, the processing apparatus comprises a memory, and the video processor is arranged to send video data to and retrieve video data from the memory during processing of the video data, and the audio processor is arranged such that the drive signals for driving the one or more invisible light pixels of a said display screen to output invisible light which encodes the audio are sent to and retrieved from the memory at substantially the same time as the corresponding video data is sent to and retrieved from the memory and prior to the drive signals being sent to a said display screen.

In an example, the video processor is arranged to provide frame-based processing of the input video image signals during which video data is sent to and retrieved from the memory.

The frame-based processing may be, for example, for one or more of noise reduction, motion estimation and motion compensation.

According to a second aspect disclosed herein, there is provided a method of driving a display screen having one or more visible light pixels for outputting visible light and one or more invisible light pixels for outputting invisible light, the method comprising:

receiving video image and audio signals;

processing input video image signals received at the input to provide corresponding drive signals for driving the one or more visible light pixels of the display screen to output visible light so as to display the video image; and

processing input audio signals received at the input to provide corresponding drive signals for driving the one or more invisible light pixels of the display screen to output invisible light which encodes the audio.

In an example, video data is sent to and retrieved from a memory during processing of the video data, and the drive signals for driving the one or more invisible light pixels of the display screen to output invisible light which encodes the audio are sent to and retrieved from the memory at substantially the same time as the corresponding video data is sent to and retrieved from the memory and prior to the drive signals being sent to the display screen.

In an example, the processing provides frame-based processing of the input video image signals during which video data is sent to and retrieved from the memory.

According to a third aspect disclosed herein, there is provided a display screen, the display screen comprising:

one or more visible light pixels for outputting visible light; and

one or more invisible light pixels for outputting invisible light;

wherein the display screen is arranged to receive drive signals for driving the one or more visible light pixels to output visible light so as to display the video image; and

wherein the display screen is arranged to receive drive signals for driving the one or more invisible light pixels to output invisible light which encodes the audio.

In an example, the display screen comprises plural pixels, at least some of the pixels comprising RGB sub-pixels which are visible light pixels and at least one infrared pixel which is an invisible light pixel.

According to a fourth aspect disclosed herein, there is provided a method of operating a display screen, the display screen comprising one or more visible light pixels for outputting visible light and one or more invisible light pixels for outputting invisible light, the method comprising:

receiving drive signals for driving the one or more visible light pixels to output visible light so as to display the video image, and outputting the visible light accordingly to display the video image; and

receiving drive signals for driving the one or more invisible light pixels to output invisible light which encodes the audio, and outputting the invisible light accordingly to wirelessly transmit the audio using invisible light.

There may also be provided a device comprising processing apparatus as described above and a display screen as described above.

### BRIEF DESCRIPTION OF THE DRAWINGS

To assist understanding of the present disclosure and to show how embodiments may be put into effect, reference is made by way of example to the accompanying drawings in which:

FIG. 1 shows schematically a known display screen;

FIG. 2 shows schematically a known processing arrangement for video and audio;

FIG. 3 shows schematically an example of a display screen according to the present disclosure;

FIG. 4 shows schematically a first example of processing apparatus according to the present disclosure; and

FIG. 5 shows schematically a second example of processing apparatus according to the present disclosure.

### DETAILED DESCRIPTION

In examples described herein, invisible light pixels in a display screen are used to output invisible light which encodes audio, so that the invisible light can be received and decoded by an audio playback device. The display screen also has visible light pixels for outputting visible light to display the related video images. The invisible light may have a frequency that does not cause interference with other wireless signals that may be present in the environment, such as Bluetooth or WiFi wireless signals. This also avoids having to provide a separate wireless transmitter solely for wirelessly transmitting audio. Furthermore, in some examples discussed further below, the processing apparatus for driving the display screen may be arranged so as to maintain synchronisation between the audio and the related video that is played back, or at least to more closely maintain the synchronisation between the audio and the related video.

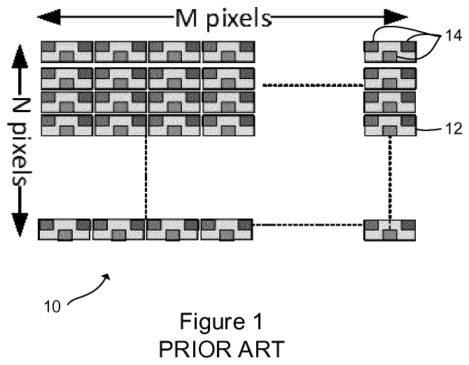

Referring first to FIG. 1, this shows schematically a known display screen 10. The display screen 10 has a number of display cells or elements 12. As will be discussed further below, examples described herein may be applied to or for display screens of a number of different types, including those with passive display cells or elements which are illuminated by a backlight to generate the image (such as in LCD (liquid crystal display) and “quantum dot” screens) and those with active or emissive display cells or elements which output light directly to generate the image (such as screens that use OLED (organic light emitting diode) or inorganic LEDs, including for example an LED display or “wall” or a micro LED display, and plasma screens). Display cells or elements in display screens are often referred to as “pixels” as they typically correspond to pixels in the image that is displayed. Moreover, terms such as drive signals for driving the pixels of a display screen to output light will be used herein, and it will be understood that this may include both drive signals that cause active or emissive display cells or elements to output light as required as well as drive signals that cause backlights and corresponding passive display cells or elements to operate so that light is output as required.

The display cells 12 of the known display screen 10 output visible light, which is used to output the video image that is being played back. The display screen has M display cells 12 in the horizontal direction and N display cells 12 in the vertical direction. As is common, each display cell 12 has a red, a green and a blue “sub-pixel” 14 (indicated by different shading in FIG. 1) for outputting red, green and blue light respectively. The term “sub-pixel” is often used by convention to indicate the individual different colour elements in each display cell/pixel 12. However, for simplicity the term “pixel” will typically be used herein to describe any display element that outputs light, and will typically mean therefore an individual display element that outputs light of a particular colour, such as a so-called “sub-pixel”, unless the context requires otherwise.

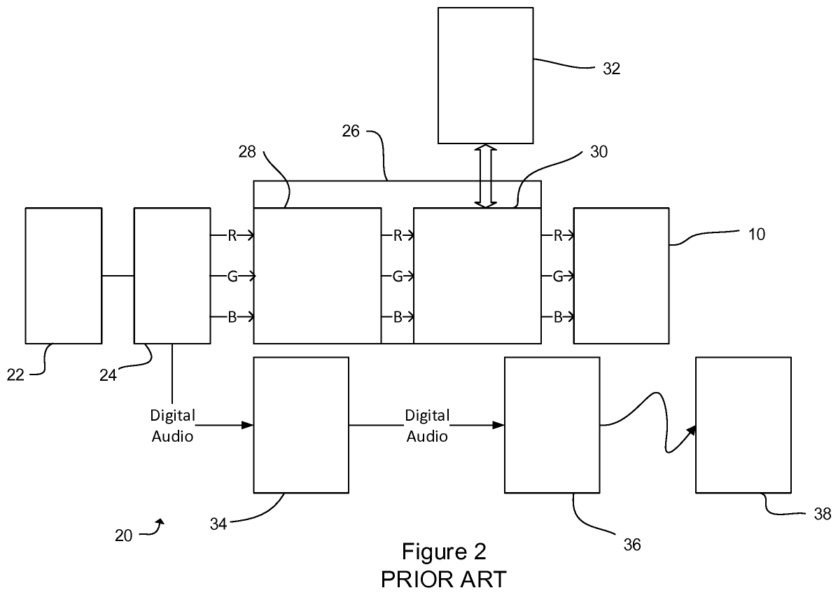

Referring to FIG. 2, this shows schematically a known processing arrangement 20 for processing video and audio input signals to allow the video and audio to be played back. Video and audio signals are received at an input 22 from a source. The video and audio signals may in general be analogue or digital signals and are normally synchronised with each other in the input. If the input signals are analogue, then an analogue-to-digital (ADC) converter 24 converts the signals to digital format. Then, in the known processing arrangement 20, the video and audio signals are processed separately.

In particular, the RGB (red, green, blue) video data is sent to a video processor 26. The video processor 26 processes the video data so as to be able to provide appropriate drive signals for driving the pixels 12 of a display screen 10. Various different processing of the input video data may be carried out. Commonly, the video processing may be one of two distinct types. A first type 28 involves pixel-based processing and line-based processing, which in general determine one or more of the colour, contrast and brightness of the displayed image. A second type 30 involves frame-based processing, such as for example for noise reduction, motion estimation, motion compensation and other, similar picture improvement techniques. For the frame-based processing, each frame of the image is sent to memory 32, which may be for example DDR (double data rate) memory. Each frame of the image is typically compared with the previous frame and the next frame and any required modification of the RGB data is applied. It may be noted that the frame-based processing and sending of the RGB data to the memory 32 and receiving the data back from the memory 32 can take a relatively long time. Moreover, the video processor 26 may send more or fewer frames to the memory 32 at any particular time. This can make it difficult to predict or control the processing delays that occur during frame-based processing. After the video processor 26 completes the processing of the video data, the video processor 26 then sends drive signals to the display screen 10 to drive the display cells 12 (or more specifically the RGB sub-pixels 14) of the display screen 10 to output the desired RGB light.

Separately, the (digital) audio data is sent to an audio processor 34. In this case, because the audio is to be transmitted wirelessly to an audio playback device, the audio processor 34 sends appropriate processed digital audio signals to a wireless transmitter 36, which may be for example a Bluetooth transmitter, a WiFi transmitter, etc. The wireless transmitter 36 then transmits wireless audio data for receipt by an audio playback device 38, such as headphones, wireless loudspeakers, etc., to enable the audio playback device 38 to play back the audio for the user.

This known processing arrangement 20 therefore requires a separate wireless transmitter 36 for the audio. As mentioned, this may be for example a Bluetooth or WiFi transmitter. However, not all display screens 10 are provided with Bluetooth or WiFi transmitters. Moreover, such wireless transmitters take space, whether in the display device itself or as a separate component. There is always a desire for the display screen 10 to be as compact or slim as possible (whether used as for example a television or computer screen or a screen of a smart phone or tablet computer, etc.).

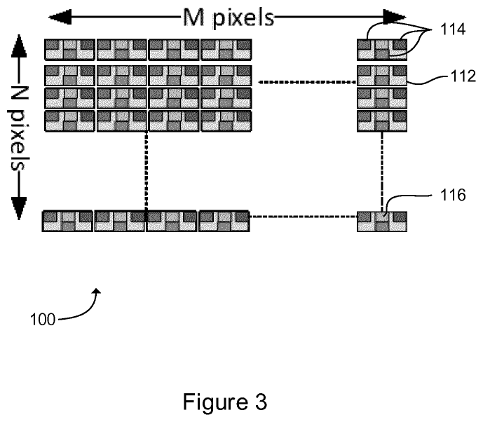

Referring now to FIG. 3, this shows schematically an example of a display screen 100 according to the present disclosure. The screen 100 may be for example a television or computer screen, a screen used in public places as so-called “signage”, a screen of a smart phone or a tablet computer, etc.

Similar to the known display screen 10 discussed above, the display screen 100 according to the present disclosure has a number of display cells or elements 112. The display screen 100 may be one of a number of different types, including those with passive display cells or elements which are illuminated by a backlight to generate the image (such as in for example LCD (liquid crystal display) and “quantum dot” screens) and those with active or emissive display cells or elements which output light directly to generate the image (such as screens that use OLEDs (organic light emitting diodes) or inorganic LEDs, including for example an LED display or “wall” or a micro LED display, and plasma screens). It is noted again that display cells or elements are also often referred to as “pixels” as they typically correspond to pixels in the image that is displayed.

In this example, each display cell 112 has a red, a green and a blue pixel (or “sub-pixel”) 114 for outputting visible red, green and blue light respectively. The different red, green and blue pixels 114 are indicated by different shading in FIG. 3. Moreover, in this example, each display cell 112 has an invisible light pixel 116 for outputting invisible light, again indicated by different shading in FIG. 3. It may be noted that not all display cells 112 need to have invisible light pixels and some may have only visible light pixels. Likewise, not all display cells 112 need to have visible light pixels and some may have only invisible light pixels. In some examples, it may be sufficient if there is a single invisible light pixel 116 for outputting invisible light.

In short, the visible light pixels 114 are used to cause an image to be displayed for viewing by a user. On the other hand, the or each invisible light pixel 116 is used to transmit encoded audio data wirelessly using invisible light to an audio playback device. In this regard, visible light is typically defined as light with a wavelength in the range 380 to 740 nanometres. Invisible light may be defined as light outside this visible range. In a particular example, the invisible light pixels 116 generate or output infrared. Infrared is typically defined as light with a wavelength in the range 700 nanometres to 1 millimetre. As a particular example, current infrared LEDs typically emit infrared with a wavelength in the range 800 to 1000 nm or so.

Use of invisible light pixels 116 in the display screen 100 to transmit the encoded audio means that no separate wireless transmitter for the audio is required: the display screen 100 both outputs visible light for the image and outputs invisible light for the encoded audio. This means that the user does not have to provide and find room for some separate wireless transmitter (which would otherwise have to be located somewhere in the vicinity of the display screen 100, which may not be convenient and may be unsightly). It also means that the display screen 100 itself does not have to have a separate wireless transmitter just for outputting wireless audio signals. Furthermore, the invisible light may have a frequency that does not cause interference with other wireless signals that may be present in the environment. As particular examples, Bluetooth typically uses a frequency in the range 2.400 to 2.485 GHz and WiFi typically uses a frequency in the range 900 MHz to 5 GHz (though frequencies up to 60 GHz may be used in accordance with current WiFi standards). The invisible light pixels 116 can be selected or arranged to output frequencies outside these ranges. As a particular example in the case of infrared which is defined as a wavelength in the range 700 nanometres to 1 millimetre, this corresponds to a frequency in the range 430 THz to 300 GHz for infrared.

It is mentioned here that it is known to use infrared to transmit audio wirelessly. For example, there are audio systems that are used in conference centres and the like in which infrared is used to transmit audio to headphones which are worn by attendees. Accordingly, the basic technology and processing required to transmit audio using infrared is known of itself and is available.

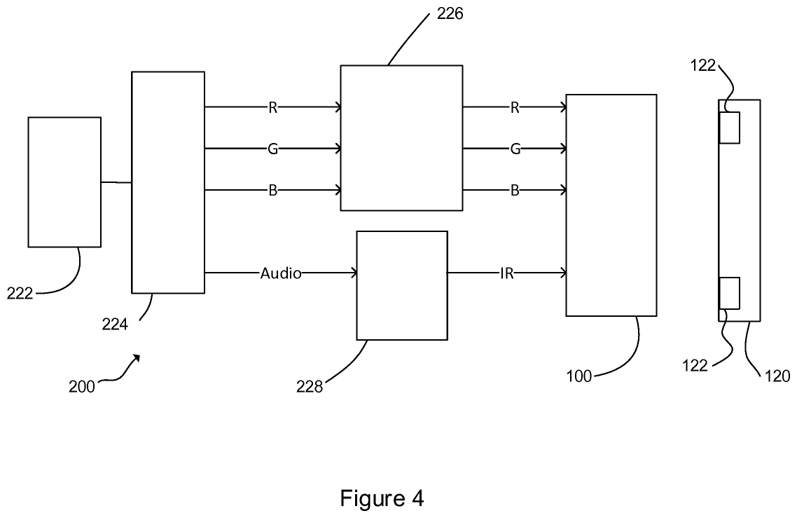

Referring now to FIG. 4, this shows schematically a first example of processing apparatus 200 according to the present disclosure. The processing apparatus 200 may be present in a device having an integral display screen 100, such as for example a television set or computer with an integrated screen, so-called signage, a smart phone, a tablet computer, etc. In the case particularly of a television set, the processing apparatus 200 may be part of the mainboard of the television set. In other examples, the processing apparatus 200 may be provided separately of the display screen, and may be a dedicated video and audio processing apparatus, or part of a DVD player or other playback device, a set-top box, a computer, etc.

The processing apparatus 200 receives video and audio signals at an input 222 from a source. The video and audio signals may be received at the input 222 from one of a number of sources, including for example a satellite, cable or terrestrial television broadcast, an IPTV (Internet Protocol television) multicast or IPTV unicast, a locally stored copy of the video and audio, etc. The video and audio signals may in general be analogue or digital signals and are normally synchronised with each other in the input. If the input signals are analogue, then an ADC converter 224 converts the signals to digital format.

The digital RGB (red, green, blue) video data is sent from the ADC converter 224 to a video processor 226. The video processor 226 processes the video data so as to be able to provide appropriate drive signals for driving the pixels 112 of the display screen 100. Various different processing of the input video data may be carried out, including for example processing as discussed above in relation to FIG. 2. After the video processor 226 completes the processing of the video data, the video processor 226 then sends corresponding drive signals to the display screen 100, typically over a wired connection, to drive the RGB pixels (or “sub-pixels”) 114 of the display screen 100 to output the desired RGB light so as to display the video image.

In addition, the digital audio data is sent from the ADC converter 224 to an audio processor 228. In this case, because the audio is to be transmitted wirelessly to an audio playback device 120 using invisible light output by one or more invisible light pixels 116 in the display screen 100, amongst other things, the audio processor 228 processes the incoming audio data so as to provide appropriate, corresponding drive signals for driving the invisible light pixels 116 to output the encoded invisible light. For example, the invisible light that is output by the display screen 100 for the audio may encode the audio using PCM (pulse code modulation), S/PDIF (Sony/Philips Digital Interface) format, or some other serial audio line communication protocol. The audio processor 228 therefore outputs drive signals for driving the invisible light pixels 116 so that the invisible light that is output encodes the audio into the invisible light in accordance with the desired format.

In this regard, it is noted that pixels in a display screen, including for example LCD pixels, can typically be turned on and off at very high frequencies, such as up to around 20 MHz or so. In principle therefore, a single invisible light pixel 116 switching at such a high rate can therefore easily accommodate audio being transmitted at high quality, such as for example in accordance with the format used in the DAT (digital audio tape) format and the format used in CD (compact disc) audio. As another option, the invisible light pixels 116 are switched on and off at one of the usual operating frequencies used for display screens or for backlights for display screens (which in general may be for example 50 Hz, 60 Hz, 100 Hz, 120 Hz, 200 Hz, etc.). In such a case that uses a lower switching rate for the invisible light pixels 116, multiple invisible light pixels 116 may be used substantially simultaneously to transmit the bits of the encoded audio so as to achieve a desired or satisfactory bit rate and therefore quality for the audio. In another variant, multiple ones of the invisible light pixels 116 may be used simultaneously to transmit each bit of data, which increases the effective transmission range. As a specific example, assume that the display screen has a resolution of 1920 pixels by 1080 pixels which are switched at 50 Hz. The bit rate for CD quality is 1,411,200 bits per second. Therefore, to achieve CD quality, a total of 73 or 74 pixels may be used simultaneously to transmit the bits (1920×1080×50/1,411,200=73.5). A smaller number of pixels may be used simultaneously to transmit bits if a lower quality for audio may be used, such as used in DAT or MP3.

The audio playback device 120, such as headphones, a wireless loudspeaker, etc., has one or more light sensors 122 for detecting the invisible light output by the display screen 100. The or each light sensor 122 may be for example a photodiode or some other light detector, which is arranged to detect and respond to light of a wavelength emitted by the invisible light pixel(s) 116. A processor of the audio playback device 120 processes the output of the or each light sensor 122 to decode the received signal and drive the speaker or other transducer of the audio playback device 120 to play back the audio for the user. It may be noted that, especially in the case that the audio playback device 120 is headphones, the user will typically be directly in front of the display screen 100 so as to be able to view images on the display screen 100, and therefore the audio playback headphones 120 will already be in a good location to receive the invisible light that is transmitted by the display screen 100 for the audio.

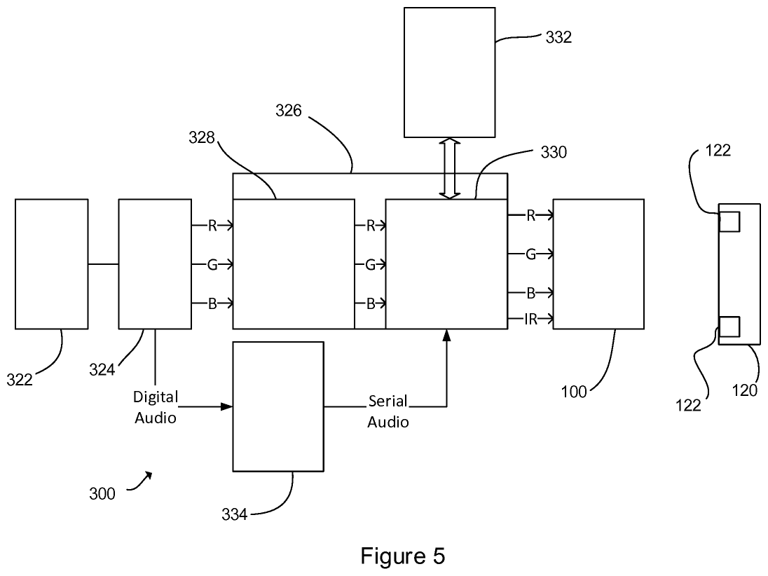

Referring now to FIG. 5, this shows schematically a second example of processing apparatus 300 according to the present disclosure. Again, the processing apparatus 300 may be present in a device having an integral display screen 100, such as for example a television set or computer with an integrated screen, so-called signage, a smart phone, a tablet computer, etc. In the case particularly of a television set, the processing apparatus 300 may be part of the mainboard of the television set. In other examples, the processing apparatus 300 may be provided separately of the display screen, and may be a dedicated video and audio processing apparatus, or part of a DVD player or other playback device, a set-top box, a computer, etc.

The processing apparatus 300 receives video and audio signals at an input 322 from a source. The video and audio signals may be received at the input 322 from one of a number of sources, including for example a satellite, cable or terrestrial television broadcast, an IPTV (Internet Protocol television) multicast or IPTV unicast, a locally stored copy of the video and audio, etc. The video and audio signals may in general be analogue or digital signals and are normally synchronised with each other in the input. If the input signals are analogue, then an ADC converter 324 converts the signals to digital format.

The digital RGB (red, green, blue) video data is sent from the ADC converter 324 to a video processor 326. The video processor 326 processes the video data so as to be able to provide appropriate drive signals for driving the pixels 112 of the display screen 100. After the video processor 326 completes the processing of the video data, the video processor 326 then sends corresponding drive signals to the display screen 100, typically over a wired connection, to drive the RGB pixels (or “sub-pixels”) 114 of the display screen 100 to output the desired RGB light to display the video image.

Separately, the digital audio data is sent from the ADC converter 324 to an audio processor 334. The audio processor 334 processes the incoming audio data so as to provide appropriate, corresponding drive signals for driving the invisible light pixels 116 of the display screen 100. For example, the invisible light that is output by the display screen 100 for the audio may encode the audio using PCM (pulse code modulation), S/PDIF (Sony/Philips Digital Interface) format, or some other serial audio line communication protocol. The audio processor 334 therefore outputs drive signals for driving the invisible light pixels 116 so that the invisible light that is output encodes the audio into the invisible light in accordance with the desired format.

Referring back to the video processing that takes place, in this example and similarly to the known system described above with reference to FIG. 2, the video processing may be one of two distinct types. A first type 328 involves pixel-based processing and line-based processing (that is, processing on individual pixels and processing on lines of pixels respectively), which in general determine one or more of the colour, contrast and brightness of the pixels and the overall displayed image. A second type 330 involves frame-based processing (that is, processing on entire frames of pixels), such as for example for one or more of noise reduction, motion estimation, motion compensation and other, similar picture improvement techniques. For the frame-based processing, each frame of the image is sent to memory 332, such as for example DDR (double data rate) memory. Each frame of the image is typically compared with the previous frame and the next frame and any required modification of the RGB data is applied.

As mentioned above, the frame-based processing and sending of the RGB data to the memory 332 and receiving the data back from the memory 332 can take a relatively long time. Moreover, the video processor 326 may send more or fewer frames to the memory 332 at any particular time. This all makes it difficult to predict or control the processing delays that occur during frame-based processing of the RGB data.

This effect of the video processing, and in particular the frame-based processing, means that in known systems, such as described above with reference to FIG. 2, the audio signals and the video signals may no longer be synchronised. That is, the video that is being played back may be delayed or advanced relative to the audio that is being played back. This problem is exacerbated when Bluetooth is used to transmit the audio to the audio playback device as Bluetooth has its own codec arrangement which can introduce unpredictable delays in transmitted audio in known systems.

This is addressed in this second example of the processing apparatus 300 as follows. The serial audio data that is output by the audio processor 334 is sent to the frame-based processing portion 330 of the video processor 326. That serial audio data, which represents drive signals for driving the invisible light pixel(s) 116 of the display screen 100, is sent to the memory 332 at the same time as the RGB data is sent to the memory 332 as part of the frame-based processing. The RGB data is processed and modified as necessary for improving the image, including for example for one or more of noise reduction, motion estimation, motion compensation and other, similar picture improvement techniques. However, the serial audio data is not modified. Instead, the serial audio data is simply sent to the memory 332 and read back from the memory 332 at the same time as the corresponding RGB data. This means that any delays to the RGB data which may arise because of the frame-based processing are also applied to the audio data. As such, the RGB data and the audio data remain synchronised or, at least, remain synchronised to a far greater extent than in arrangements such as described with reference to FIG. 2. In general, the RGB data and the audio data should remain synchronised within around 50 ms or so, as delays or advancement of the audio relative to the video of more than around 50 ms is noticeable to users.

In short, in this example the audio drive signals for driving the invisible light pixel(s) 116 of the display screen 100 are handled similarly to the drive signals for driving the visible light pixels 114 of the display screen in that similar delays are introduced during processing, even though the audio drive signals are not changed during the processing of the drive signals for driving the visible light pixels 114.

This second example has been described to deal with the relatively long and unpredictable time delays that can occur during frame-based processing of the visible RGB light signals. This can be extended if other long or unpredictable time delays occur during processing of the visible RGB light signals. In particular, in other examples the serialised audio that is output by the audio processor 334 may in general be composed with the RGB video data at any suitable point during the processing of the RGB data to ensure that the audio data and the RGB video data are subject to (substantially) the same delays and therefore remain (substantially) synchronised.

It will be understood that the processor or processing system or circuitry referred to herein may in practice be provided by a single chip or integrated circuit or plural chips or integrated circuits, optionally provided as a chipset, an application-specific integrated circuit (ASIC), field-programmable gate array (FPGA), digital signal processor (DSP), graphics processing units (GPUs), etc. The chip or chips may comprise circuitry (as well as possibly firmware) for embodying at least one or more of a data processor or processors, a digital signal processor or processors, baseband circuitry and radio frequency circuitry, which are configurable so as to operate in accordance with the exemplary embodiments. In this regard, the exemplary embodiments may be implemented at least in part by computer software stored in (non-transitory) memory and executable by the processor, or by hardware, or by a combination of tangibly stored software and hardware (and tangibly stored firmware).

Reference is made herein to data storage for storing data. This may be provided by a single device or by plural devices. Suitable devices include for example a hard disk and non-volatile semiconductor memory (including for example a solid-state drive or SSD).

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

The examples described herein are to be understood as illustrative examples of embodiments of the invention. Further embodiments and examples are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the invention, which is defined in the claims.

1. Processing apparatus for driving a display screen having one or more visible light pixels for outputting visible light and one or more invisible light pixels for outputting invisible light, the apparatus comprising:
an input for receiving video image and audio signals;
a video processor constructed and arranged to process input video image signals received at the input and to provide corresponding drive signals for driving the one or more visible light pixels of a said display screen to output visible light so as to display the video image; and
an audio processor constructed and arranged to process input audio signals received at the input and to provide corresponding drive signals for driving the one or more invisible light pixels of a said display screen to output invisible light which encodes the audio.

2. Processing apparatus according to claim 1, wherein the processing apparatus is arranged such that the processing of the input video image signals and the processing of the input audio signals takes substantially the same amount of time such that the corresponding drive signals for driving the one or more visible light pixels of a said display screen and the drive signals for driving the one or more invisible light pixels of a said display screen are substantially synchronised with each other.

3. Processing apparatus according to claim 1, comprising a memory, wherein the video processor is arranged to send video data to and retrieve video data from the memory during processing of the video data, and wherein the audio processor is arranged such that the drive signals for driving the one or more invisible light pixels of a said display screen to output invisible light which encodes the audio are sent to and retrieved from the memory at substantially the same time as the corresponding video data is sent to and retrieved from the memory and prior to the drive signals being sent to a said display screen.

4. Processing apparatus according to claim 3, wherein the video processor is arranged to provide frame-based processing of the input video image signals during which video data is sent to and retrieved from the memory.

5. A method of driving a display screen having one or more visible light pixels for outputting visible light and one or more invisible light pixels for outputting invisible light, the method comprising:
receiving video image and audio signals;
processing input video image signals received at the input to provide corresponding drive signals for driving the one or more visible light pixels of the display screen to output visible light so as to display the video image; and
processing input audio signals received at the input to provide corresponding drive signals for driving the one or more invisible light pixels of the display screen to output invisible light which encodes the audio.

6. A method according to claim 5, wherein video data is sent to and retrieved from a memory during processing of the video data, and wherein the drive signals for driving the one or more invisible light pixels of the display screen to output invisible light which encodes the audio are sent to and retrieved from the memory at substantially the same time as the corresponding video data is sent to and retrieved from the memory and prior to the drive signals being sent to the display screen.

7. A method according to claim 6, wherein the processing provides frame-based processing of the input video image signals during which video data is sent to and retrieved from the memory.

8. A display screen, the display screen comprising:
one or more visible light pixels for outputting visible light; and
one or more invisible light pixels for outputting invisible light;
wherein the display screen is arranged to receive drive signals for driving the one or more visible light pixels to output visible light so as to display the video image; and
wherein the display screen is arranged to receive drive signals for driving the one or more invisible light pixels to output invisible light which encodes the audio.

9. A display screen according to claim 8, wherein the display screen comprises plural pixels, at least some of the pixels comprising RGB sub-pixels which are visible light pixels and at least one infrared pixel which is an invisible light pixel.

10. A method of operating a display screen, the display screen comprising one or more visible light pixels for outputting visible light and one or more invisible light pixels for outputting invisible light, the method comprising:
receiving drive signals for driving the one or more visible light pixels to output visible light so as to display the video image, and outputting the visible light accordingly to display the video image; and
receiving drive signals for driving the one or more invisible light pixels to output invisible light which encodes the audio, and outputting the invisible light accordingly to wirelessly transmit the audio using invisible light.

11. A device comprising the processing apparatus according to claim 1 and a display screen, the display screen comprising:
the one or more visible light pixels for outputting the visible light; and
the one or more invisible light pixels for outputting the invisible light;
wherein the display screen is arranged to receive the drive signals for driving the one or more visible light pixels to output the visible light so as to display the video image; and
wherein the display screen is arranged to receive the drive signals for driving the one or more invisible light pixels to output the invisible light which encodes the audio.
